(19) United States
(12) Patent Application Publication
(10) Pub. No.: US 2017/0322686 A1
(43) Pub. Date: Nov. 9, 2017

(54) Multi-Stage Menu Selection Method and Electronic Device for Performing Same

(71) Applicant: Dae-Geon HONG, Yongin-si (KR)

(72) Inventor: Dae-Geon HONG, Yongin-si (KR)

(21) Appl. No.: 15/585,873

(22) Filed: May 3, 2017

(30) Foreign Application Priority Data
May 4, 2016 (KR) 1020160055097

(51) Int. Cl. G06F 3/0482; G06F 3/0481; G06F 3/0484; G06F 3/0488

(52) U.S. Cl. CPC G06F 3/0482; G06F 3/0488; G06F 3/04817; G06F 3/04845

(57) ABSTRACT

The present invention provides a multi-stage menu selection method for enhancing the user's convenience by displaying menus step by step when a large number of menus need to be displayed on a display having a small size compared to the number of the menus, and an electronic device for performing the method.

### CROSS REFERENCE TO RELATED APPLICATION(S)

This application claims the benefit of Korean Patent Application No. 10-2016-0055097, filed May 4, 2016, which is hereby incorporated by reference in its entirety, including any figures, tables, or drawings.

### TECHNICAL FIELD

The present disclosure relates to a multi-stage menu selection method for enhancing the user's convenience by displaying menus step by step when a large number of menus need to be displayed on a display having a small size compared to the number of the menus, and an electronic device for performing the method.

### BACKGROUND

Along with the development of information communication technology, there is a flood of various portable electronic devices. Particularly, in recent years, attention is paid to a wearable computer which is an electronic device wearable on a person's body in the form of glasses, a watch, a cloth or the like and which has enhanced portability and convenience. Among these wearable computers, the most popular one is a smart watch which is worn on a person's wrist.

However, since the wearable computer including such a smart watch is worn on a body part such as the wrist of a person or the like, it is difficult for the wearable computer to become larger than a certain level. As a result, the size of a touch screen type display generally provided in the wearable computer is limited as well. This may cause discomfort for a user who touches a display in order to operate the wearable computer.

For example, it is assumed that for a user attempting to input alphabetic characters on a wearable computer, a virtual keyboard is displayed on a display of the wearable computer and provided to a user. In such a case, 26 keys respectively corresponding to 26 alphabetic characters may be simultaneously displayed on the display, as those of the keyboard of a typical PC (personal computer). Then, the size of each of the keys becomes very small due to the small size of the display. Thus, the user may suffer great inconvenience for an input work. In order to solve these problems, in the prior art, there has been used a character input method using a virtual keyboard 10 as shown in FIG. 1.

The virtual keyboard 10 includes a plurality of keys 11 for the character input and enables different characters to be inputted according to the number of times of pressing one key. For example, if the key reading “ABC” of the virtual keyboard 10 shown in FIG. 1 is pressed once, “A” is inputted. If the key reading “ABC” is pressed twice, “B” is inputted. If the key reading “ABC” is pressed three times, “C” is inputted. According to this method, it is possible to input multiple characters with one key. This makes it possible to secure the size of keys to the extent that the user does not feel inconvenience.

However, in the character input method shown in FIG. 1, the increase in the number of touch times for inputting characters may become a problem. For example, in order to input a three-character word “YES” using the character input method shown in FIG. 1, it is necessary to make touch nine times in total, including the touch of a “WXYZ” key three times, the touch of a “DEF” key twice and the touch of a “PQRS” key four times. The excessive number of times of touch compared with the number of characters may cause inconvenience and mistake to the user.

### PRIOR ART DOCUMENTS

### Patent Documents

Patent Document 1: Korean Patent Application Publication No. 10-2014-0051201 (published on Apr. 30, 2014)

### SUMMARY

Embodiments of the present disclosure provide a device and method which makes it possible to perform an operation desired by a user, such as a character input operation or the like, through a minimum number of inputs even when a space for the input is limited in an electronic device including a wearable computer.

However, the problems to be solved by the present disclosure are not limited to what is mentioned above. Other problems to be solved, which are not mentioned above, will be clearly understood from the following description by a person having ordinary knowledge in the field to which the present disclosure belongs.

According to one embodiment of the present disclosure, it is possible to prevent user's inconvenience or mistake by adopting a multi-stage menu selection method. According to the method, only a predetermined number of menus among total menus may be preferentially displayed, and then, the other menus may be displayed based on the subsequent input operations of the user.

Specifically, when inputting characters via a touch screen type display of a small electronic device, it is possible to reduce the number of input operations required on average as compared with the conventional method. This makes it possible to achieve efficiency and convenience in the character input.

### BRIEF DESCRIPTION OF THE DRAWINGS

FIG. 1 is a diagram showing a character input method using a virtual keyboard in an electronic device having a touch screen type display according to the prior art.

FIG. 2 is a diagram showing a configuration of an electronic device having a multi-stage menu selection function according to one embodiment of the present disclosure.

FIG. 3 is a flowchart showing a procedure of a multi-stage menu selection method in the electronic device according to one embodiment of the present disclosure.

FIG. 4 is a diagram showing a situation in which primary menus are displayed through a display in the electronic device having a multi-stage menu selection function according to one embodiment of the present disclosure.

FIGS. 5A and 5B are diagrams illustrating a process of detecting an input for selecting any one of non-display regions and displaying menus matched to the selected non-display region in the electronic device having a multi-stage menu selection function according to one embodiment of the present disclosure.

FIGS. 6A to 6C are diagrams showing an operation in a case where there is a plurality of menu sets each including a plurality of menus, in the electronic device having a multi-stage menu selection function according to one embodiment of the present disclosure.

FIGS. 7A to 7E and 8A to 8D are diagrams showing a process of selecting a menu by the combination of a touch operation and a drag operation in the electronic device having a multi-stage menu selection function according to one embodiment of the present disclosure.

FIGS. 9A to 9D are diagrams showing a process of changing the display state of a menu by a drag operation in the electronic device having a multi-stage menu selection function according to one embodiment of the present disclosure.

### DETAILED DESCRIPTION

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions and/or constitutions will not be described in detail if they would unnecessarily obscure the features of the present invention in unnecessary detail. Further, the terms to be described below are defined in consideration of their functions in the embodiments of the present invention and may vary depending on a user's or operator's intention or practice. Accordingly, the definition may be made on a basis of the content throughout the specification.

Hereinafter, the embodiments of the present invention will be described in detail with reference to the accompanying drawings.

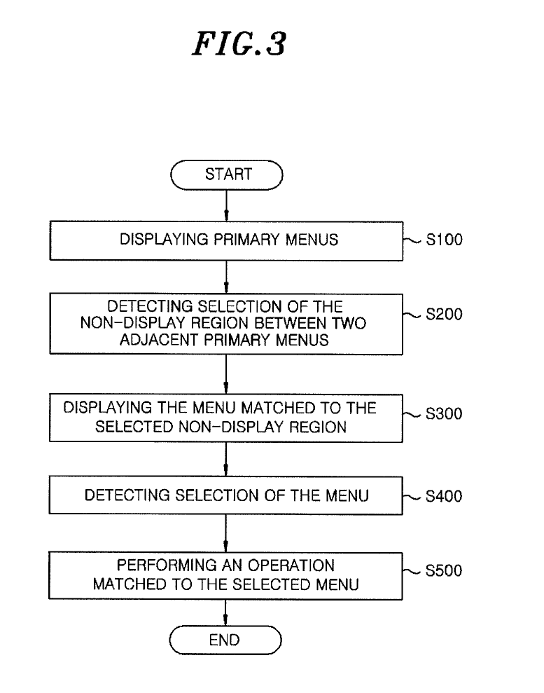

FIG. 2 is a diagram showing a configuration of an electronic device having a multi-stage menu selection function according to one embodiment of the present disclosure. Since the electronic device 100 shown in FIG. 2 is nothing more than one embodiment of the present disclosure, the concept of the present disclosure is not construed as being limited by FIG. 2. Referring to FIG. 2, the electronic device 100 may include an input unit 110, a display 120, a control unit 130 and a storage unit 140.

The input unit 110 may detect an input signal inputted by the user of the electronic device 100 and may transfer the input signal to the control unit 130. The input unit 110 may be implemented using a keyboard or a mouse. However, in the present embodiment, it is assumed that the input unit 110 is implemented using a touch detection panel integrally formed with a touch screen type display 120. The detailed implementation method of the touch screen type display 120 including the touch detection panel is obvious to those skilled in the art. Thus, the detailed description thereof will be omitted.

The display 120 may visually display specific information under the control of the control unit 130. Such a display 120 may be implemented using a liquid crystal display (LCD), an organic light emitting diode (OLED), or the like. In the present embodiment, description will be made on the assumption that the display 120 is a touch screen type display integrally formed with the touch detection panel as described above. Specifically, according to one embodiment of the present disclosure, the display 120 may display all or a part of a plurality of predetermined menus. As used herein, the term “menu” means that, when a corresponding menu is displayed by the display 120 and a user selects the displayed menu through an input operation such as touching or the like, an operation matched to the menu may be executed by the electronic device 100. For example, the menus may be the keys of a virtual keyboard. In some cases, the menus may be shortcut icons or the like for executing application programs in the electronic device 100.

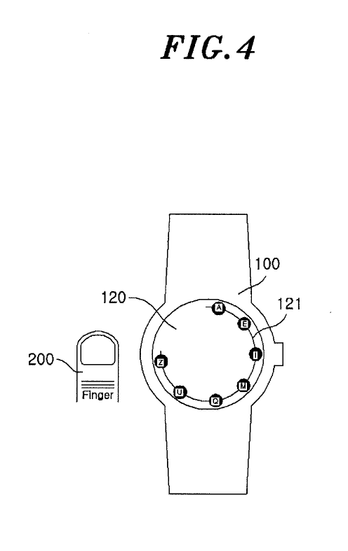

The control unit 130 may control the input unit 110, the display 120 and the storage unit 140 so that the function targeted by the electronic device 100 can be executed. In other words, a multi-stage menu selection function according to one embodiment of the present disclosure may be achieved under the control of the control unit 130. The multi-stage menu selection function will be described in detail below with reference to FIGS. 3 to 8. The control unit 130 may include a processing device such as a microprocessor.

The storage unit 140 may store data or application programs required by the electronic device 100. Specifically, according to one embodiment of the present disclosure, the storage unit 140 may store information on which of the menus described above is to be displayed and which of the operations is to be executed by the electronic device 100 under the control of the control unit 130 when a specific menu is selected. Specifically, the storage unit 140 may be a computer-readable recording medium. Examples of the computer-readable recording medium may include a magnetic medium such as a hard disk, a floppy disk, a magnetic tape or the like, an optical medium such as a CD-ROM, a DVD or the like, a magneto-optical medium such as a floptical disk or the like, and a hardware device such as a flash memory or the like specially configured to store and execute a program.

FIG. 3 is a flowchart showing a procedure of a multi-stage menu selection method performed in the electronic device according to one embodiment of the present disclosure. Hereinafter, description will be made on the assumption that the electronic device 100 for performing the multi-stage menu selection method according to one embodiment of the present disclosure is a small wearable electronic device such as a smart watch or the like provided with a touch screen type display. However, the electronic device 100 is not necessarily limited thereto. The respective steps of the multi-stage menu selection method according to one embodiment of the present invention will be described below with reference to FIG. 3. Explanation of the parts overlapping with those shown in FIG. 2 may be omitted. In addition, the respective steps described below do not necessarily have to be executed in a specific order. It goes without saying that the order of the respective steps may be changed as necessary.

First, it may be assumed that there are n menus (n is a natural number of 2 or more) which are to be displayed on the display 120. In the following description, it may be assumed that these menus are for inputting alphabetic characters. In this case, the total number n of the menus may be 26, and the respective menus may have serial numbers determined among natural numbers from 1 to n. The menus may be respectively matched to the alphabetic characters in such a way that the first menu is A, the second menu is B, . . . , and the 26^{th} menu is Z. In addition to the alphabetic characters, it is possible to input symbols having a specific order, such as Korean language characters, numbers or the like, using these menus.

Under the above conditions, m primary menus among the n menus may be respectively displayed to m predetermined first display regions defined on a predetermined first path 121 on the display 120 (S100). The number m may be a natural number of 1 or more and less than n. Such primary menus may be determined by an input from the user of the electronic device 100. Alternatively, the primary menus may be determined based on the frequency of user's selection is of n total menus. For example, by analyzing the past menu selection history of the user, the primary menus may be selected from the total menus in the order of user's frequent selection.

Alternatively, the primary menus may be determined such that the intervals between the serial numbers thereof are equal to each other. For instance, in the aforementioned example of alphabetic characters, the 1^{st} menu “A”, the 8^{th} menu “H”, the 15^{th} menu “O” and the 22^{nd} menu “V” may be selected as the m primary menus (m is 4 in this case) so that the interval between the serial numbers of the primary menus becomes 7. The user's convenience can be further improved by the aforementioned various methods of determining the m primary menus.

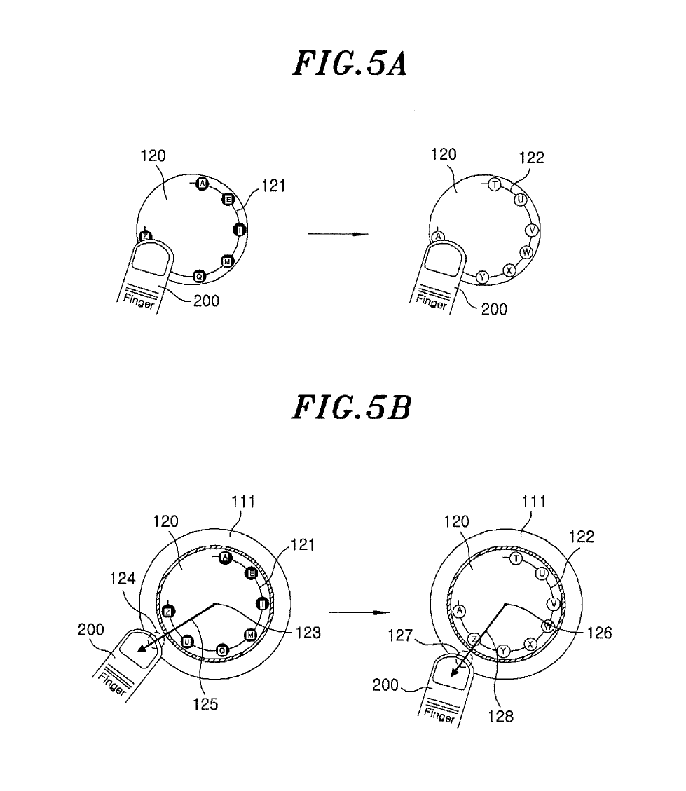

An example of such an display is shown in FIG. 4. FIG. 4 is a diagram showing a situation in which the m primary menus are displayed on the display in the electronic device having a multi-stage menu selection function according to one embodiment of the present disclosure. Referring to FIG. 4, it can be noted that the 1^{st}, 5^{th}, 9^{th}, 13^{th}, 17^{th}, 21^{st} and 26^{th} menus respectively corresponding to A, E, I, M, Q, U and Z are displayed. Therefore, in this case, m is 7 and the primary menus are the 1^{st}, 5^{th}, 9^{th}, 13^{th}, 17^{th}, 21^{st} and 26^{th} menus . It is assumed that each menu is displayed in a shape including an alphabetic character matched thereto.

Meanwhile, the displayed menus may be arranged sequentially on the first path 121 in an order of the serial numbers (in the present embodiment, in the alphabetical order). More specifically, the primary menus may be respectively displayed on m first display regions on the first path 121. In this case, there are 7 first display regions on the first path 121. At this time, the touch input at an arbitrary position on the display 120 may be performed by a user's finger 200 or a touch device such as a touch pen or the like.

Meanwhile, among the regions on the first path 121, the regions not belonging to the first display regions may be defined as non-display regions. At this time, each of the non-display regions may exist between adjacent first display regions. For example, the region on the first path 121, which exists between the first display region on which the 5th menu (E) in FIG. 4 is displayed and the first display region on which the 9^{th} menu (I) is displayed, may be one non-display region. The region on the first path 121, which exists between the first display region on which the 9^{th} menu (I) is displayed and the first display region on which the 13^{th} menu (M) is displayed, may be another non-display region. The intervals between adjacent first display regions may be defined to become equal to each other on the first path 121.

Returning to FIG. 3 again, after step S100, the input unit 110 may detect an input for selecting one of the non-display regions (S200). Then, the display 120 may display one or more menus matched to the selected non-display region on a predetermined second path on the display 120 (S300). This means each of the non-display regions may be matched with one or more menus among the n total menus.

In this case, just like the first path, a plurality of second display regions are defined on the second path. Each of one or more menus matched to the selected non-display region may be displayed to one of the second display regions. Similar to the first display regions, the second display regions may be arranged at regular intervals on the second path. In addition, the number of the menus matched to one non-display regions may be fixed to a specific number. In this case, the number of the second display regions may also be set to the specific number.

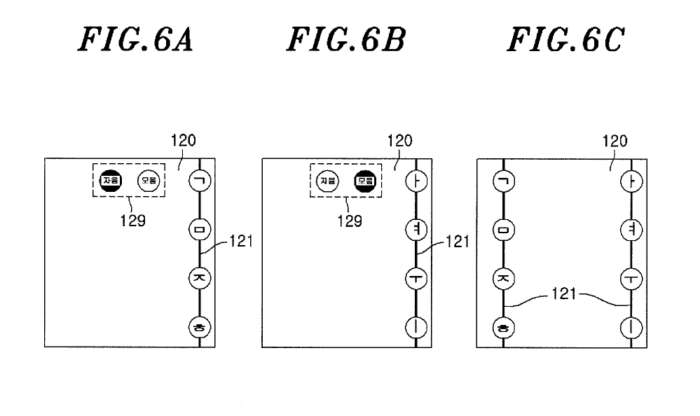

FIGS. 5A and 5B are diagrams illustrating a process of detecting an input for selecting one of the non-display regions and displaying menus matched to the selected non-display region in the multi-stage menu selection method according to one embodiment of the present disclosure. For example, referring to FIG. 5A, it can be seen that the non-display region between the 21^{st} menu “U” and the 26^{th} menu “Z” is touched by the finger 200. It can be noted that when the non-display region is touched, all menus which are matched to the touched non-display region may be displayed on the second path 122. In this case, menus from the 20^{th} menu “U” to the 26^{th} menu “Z” and the 1^{st} menu (A) are displayed.

The menus matched to a specific non-display region may follow the predetermined criteria. It is preferable to make sure that each of the n total menus is matched to at least one non-display regions, namely that a menu not matched to any one of the non-display regions does not exist.

Referring to FIG. 5A, the second path 122 may be set to share its position with the first path 121 on the display 120. Thus, when one of the non-display regions is selected, the screen of the display 120 may be switched. Then, the primary menus displayed on the first display regions on the first path 121 may be no longer displayed and the menus matched to the selected non-display region are displayed on the second path 122 on the display 120.

Alternatively, it is also possible to set the second path 122 not to overlap with the first path 121 on the display 120. In this case, the menus matched to the selected non-display region may be displayed on the second path 122 on the display 120 while maintaining the state in which the primary menus are displayed on the first path 121. The first path 121 or the second path 122 may be defined in the form of a loop extending along the peripheral edge portion of the display 120, for example, in various forms such as a circle, an arc, a part of a rectangle and the like.( [symbol] [symbol] )

On the other hand, as shown in FIG. 5B, the input unit 110 may further include another detection device in other places than on the display 120. For example, the input unit 110 may further include a touch detection unit 111 which can be implemented using a touch pad or the like and surrounds the peripheral edge portion of the display 120. In this case, when a specific position of the touch detection unit 111 shown in FIG. 5B is selected by a touch of the finger 200, it may be regarded that a region closest to the selected specific position is selected among the first display regions and the non-display regions.

For the sake of more generalized explanation, it is assumed that the first path 121 or the second path 122 has a loop shape formed along the peripheral edge portion of the display 120 as described above. In this case, if a position 124 is selected by the finger 200 when the primary menus are displayed on the first display regions on the first path 121, it may be regarded that a region including the point at which the first path 121 intersects a straight line 125 extending from the center 123 of the first path 121 and passing through the position 124 is selected among the non-display regions and the first display regions. Alternatively, if the menus matched to a specific non-display region are displayed on the second path 122 and a position 127 on the touch detection unit 111 is touched by the finger 200, it may also be regarded that the point on the second path 122 at which the second path 122 intersects a straight line 128 extending from the center 126 of the second path 122 and passing through the position 127 is selected. When a menu is displayed on the selected point, it may be regarded that the menu is selected.

Referring back to FIG. 3 again, in a state in which the menus matched to the selected non-display region are displayed on the second path 122, one of the displayed menus may be selected (S400). Then, the operation matched to the selected menu may be executed by the electronic device 100 (S500). Surely, the selection of a specific menu may mean the selection of a first output region or a second output region on which the specific menu is displayed. For example, if the 25^{th} menu “Y” on the second path 122 in FIG. 5A or 5B is selected with the finger 200 of the user, the electronic device 100 may recognize that the alphabet “Y” is inputted by the selection.

On the other hand, the user may select one of the menus displayed on the first display regions instead of the non-display regions in a state in which the primary menus are displayed on the first display regions on the first path 121 of the display 120. Then, the electronic device 100 may execute the operation matched to the selected primary menu and the step S300 may be omitted. For example, when the 1^{st} menu “A” on the first path 121 in FIG. 5A or 5B is selected, the electronic device 100 may recognize that the alphabet “A” is inputted by the selection. Alternatively, even when a menu displayed on one of the first display regions is selected, the electronic device 100 may be operated as if the non-display regions are selected. For example, when a menu displayed on an arbitrary first display region is selected, the menus matched to one of the non-display regions adjacent to the arbitrary first display region may be displayed on the second path 122. Alternatively, when one or more menus are matched to each of the first display regions and when an arbitrary first display region is selected, the menus matched to the selected first display region may be displayed on the second path 122.

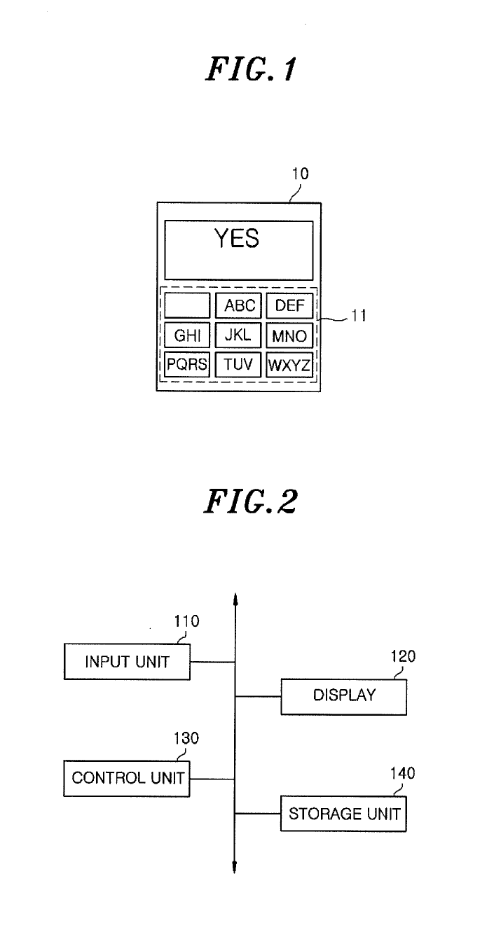

According to the process of steps S100 to S500 described above, it is possible to perform an operation (for example, the input of an English word) through a smaller number of selection actions (for example, touch) than in the prior art described with reference to FIG. 1. When trying to input the word “YES” described above as an example, nine times of touches are required in the prior art shown in FIG. 1. However, according to one embodiment of the present disclosure, one alphabet may be inputted through only two times of touch at most. Thus, the same word “YES” may be inputted with six times of touches at most. Therefore, according to one embodiment of the present disclosure, it is possible to prevent user's inconvenience and mistake, thereby achieving efficiency and convenience.

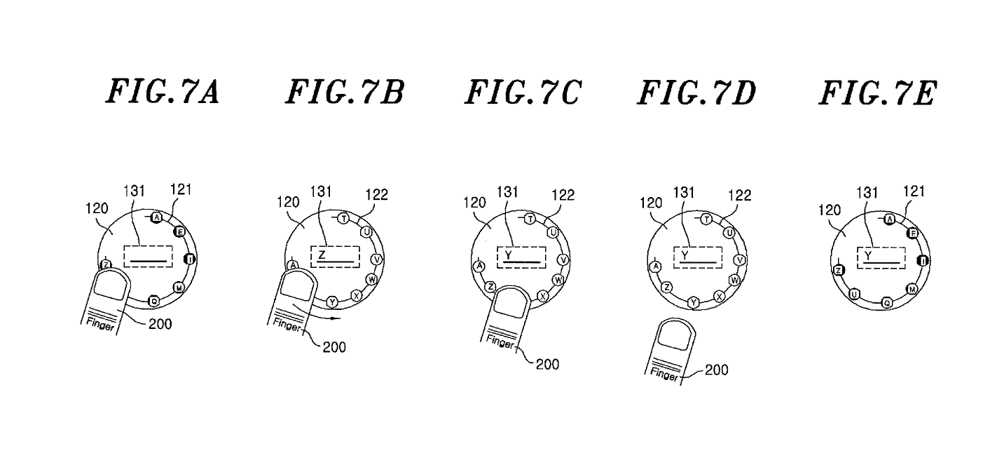

Hereinafter, various other embodiments of the present disclosure will be described with reference to FIGS. 6 to 9. Description of the parts overlapping with those shown in FIGS. 2 to 5 may be omitted.

FIGS. 6A to 6C are diagrams showing an operation in a case where there is a plurality of menu sets each including a plurality of menus, in the electronic device having a multi-stage menu selection function according to one embodiment of the present disclosure.

The process of selecting n menus having serial numbers from 1 to n has been described above with reference to FIGS. 3 to 5. However, according to embodiments, this may be further expanded to define a plurality of menu sets each of which includes a plurality of menus. For example, it may be assumed that there are two menu sets, namely a first menu set and a second menu set. In this case, the first menu set may include n menus of the 1^{st} menu, the 2^{nd} menu, . . . and the n^{th} menu, and the second menu set may include p menus of the 1^{st} menu, the 2^{nd} menu, . . . and the p^{th} menu.

Referring to FIGS. 6A to 6C, the first menu set may be defined as a menu set for selecting and inputting consonants of the Korean alphabet, and the second menu set may be defined as a menu set for selecting and inputting vowels of the Korean alphabet. In this case, it may be assumed that the first menu set includes fourteen menus composed of the 1^{st} menu “ [symbol] ”, the 2^{nd} menu “ [symbol] ”, . . . and the 14^{th} menu “ [symbol] ”, and the second menu set includes ten menus composed of the 1^{st} menu “ [symbol] ”, the 2^{nd} menu “ [symbol] ”, . . . and a 10^{th} menu “ [symbol] ”.

At this time, as shown in FIG. 6A, the predetermined primary menus of the first menu set (in this case, the 1^{st} menu “ [symbol] ”, the 5^{th} menu “ [symbol] ”, the 9^{th} menu “ [symbol] ” and the 14^{th} menu “ [symbol] ”) may be displayed on the first path 121 of the display 120. Alternatively, as shown in FIG. 6B, the predetermined primary menus of the second menu set (in this case, the 1st menu ( [symbol] ) the 4^{th} menu ( [symbol] ) the 7^{th} menu ( [symbol] ) and the 10^{th} menu ( [symbol] )) may be displayed on the first path 121 of the display 120. Switching between the first menu set and the second menu set may be performed using the menu set selection region 129 existing in an arbitrary area on the display 120.

Referring to FIG. 6A, the “consonant” menu (the left one in the menu set selection region 129) may be selected from the two menus of the menu set selection region 129. Thus, the menus belonging to the first menu set and corresponding to the consonants may be displayed on the first path 121. On the other hand, referring to FIG. 6B, the “vowel” menu (the right one in the menu set selection region 129) may be selected from the two menus of the menu set selection region 129. Thus, the menus belonging to the second menu set and corresponding to the vowels may be displayed on the first path 121.

The user may perform the switching between the aforementioned two menu sets through an operation of touching one of the two menus of the menu set selection region 129, or the like. The present embodiment is basically the same as the embodiment described above with reference to FIGS. 3 to 5 except that the menu sets can be switched in this manner. Therefore, detailed description will be omitted. According to the present embodiment, when it is necessary to input characters by combining elements belonging to different categories (for example, consonants and vowels) as in the input of the Korean language, it is possible to easily perform the switching between categories on a screen having a limited area. This enables the user to easily, conveniently and efficiently use the electronic device 100. As a matter of course, as shown in FIG. 6C, it is also possible to simultaneously execute the displays of a plurality of menu sets using different areas of the display 120 without having to use the function for the switching.

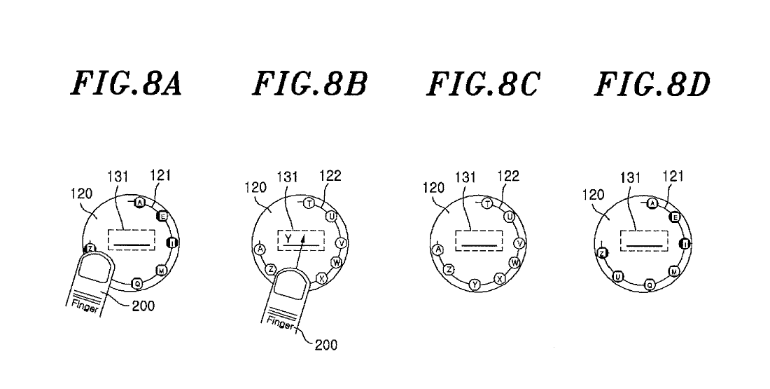

FIGS. 7A to 7E and 8A to 8D are diagrams showing a process of selecting a menu by the combination of a touch operation and a drag operation in the electronic device having a multi-stage menu selection function according to one embodiment of the present disclosure. According to the embodiment shown in FIGS. 7A to 7E and 8A to 8D, it is possible to more conveniently use the multi-stage menu selection function of the present disclosure by using a another user input means such as a drag in addition to the touch. Furthermore, according to the embodiment shown in FIGS. 7A to 7E and 8A to 8D, a selected menu display region 131 may be placed in a predetermined area on the display 120. For example, an area not overlapping with the first path 121 or the second path 122 may be used as the selected menu display region 131. The function of the selected menu display region 131 will be described later.

As described earlier with reference to FIGS. 5A and 5B, if one of the non-display regions on the first path 121 is touched in a state in which the primary menus are displayed on the first path 121 of the display 120 as shown in FIG. 7A, the screen of the display 120 may be switched as shown in FIG. 7B, whereby the menus matched to the selected non-display region may be displayed to the second path 122. Additionally, in the case of the present embodiment, it is possible to perform a drag operation along the second path 122 with the finger 200 in a state in which the touch for selecting one of the non-display regions is kept.

For example, referring to FIG. 7B, the menus matched to a specific non-display region may be displayed by a touch of the finger 200. At this time, the finger 200 can maintain the touch, thereby being put on certain position on the display 200. In the example of FIG. 7B, the finger 200 may become to touch the 26^{th} menu “Z” on the second path 122, whereby the alphabet “Z” is displayed in the selected menu display region 131. Referring to FIG. 7C, the finger 200 is moved from the 26^{th} menu “Z” to the 25^{th} menu “Y” through a drag operation while keeping the touch without releasing the finger 200 from the display 120, whereby the alphabet “Y” is displayed in the selected menu display region 131. When releasing the finger 200 from the display 120 in this state, the operation matched to the 25^{th} menu “Y” which is touched by the finger 200 when the drag operation is terminated, namely the operation of inputting the alphabet “Y”, may be performed as shown in FIG. 7D.

In addition, after one alphabet has been inputted by one operation which combines a touch and a drag, the screen of the display 120 may be converted to the initial screen in which the primary menus are displayed on the first path 121, as shown in FIG. 7E. At this time, the character (“Y” in this example) already inputted through the previously performed input operation may be fixedly displayed in the selected menu display region 131. In other words, the selected menu display region 131 may function as a general input window.

According to the embodiment of FIGS. 7A to 7E described above, it is possible to input one character by one continuous operation of “touch and drag”. Therefore, only three actions in total are executed to input an English word “YES”. It can be seen that this method is very convenient and efficient as compared with the prior art of FIG. 1 in which nine touches are required. Accordingly, the user can quickly, accurately and conveniently input characters using the electronic device 100.

In the above description, the drag operation is performed along the second path 122, which is actually desirable. However, the drag operation does not have to be performed only along the second path 122. As long as the end point of the drag exists on the position where the menu to be selected is displayed, it may be possible to execute the command matched to the menu.

On the other hand, when one of the non-display regions is selected by the touch of the finger 200 as shown in FIG. 7A, depending on which position within the selected non-display region is touched, it may be possible to determine which menu among the menus matched to the selected non-display region is to be located at the position touched by the finger 200 in FIG. 7B. More specifically, referring to FIG. 7A, it can be seen that the non-display region between the 21^{st} menu (U) and the 26^{th} menu (Z) is selected by the finger 200. It can be assumed that the length of the selected non-display region on the first path 121 is 10 mm (1 cm). When the position existing at a distance of 0 to 2.5 mm from the 26^{th} menu “Z” along the first path 121 is selected, the 25^{th} menu “Y” may be located at the position touched by the finger 200 in FIG. 7B. When the position existing at a distance of 2.5 to 5 mm from the 26^{th} menu “Z” is selected, the 24^{th} menu “X” may be located at the position. When the position existing at a distance of 5 to 7.5 mm from the 26^{th} menu “Z” is selected, the 23^{th} menu “W” may be located at the position. When the position existing at a distance of 7.5 to 10 mm from the 26^{th} menu “Z” is selected, the 22^{nd} menu “V” may be located at the position.

According to the present embodiment, the user may measure an approximate detailed position within the non-display region to be selected and may execute an accurate touch to the measured position so that the menu corresponding to the character to be inputted comes just below the finger 200 at the stage of FIG. 7B. This makes it possible to input the desired character just by an operation of touching a specific position and releasing the finger 200 without any additional drag operation. According to the present embodiment, it is possible to simplify the action required for inputting a word. This makes it possible to maximize the effect of the present disclosure.

On the other hand, referring to FIGS. 8A to 8D, when a menu is displayed on the second path 122 in a state in which the touch of the finger 200 is maintained, the finger 200 may be dragged to the area on the display 120 not belonging to the second path 122 and then may be released from the area. It is therefore possible to convert the screen of the display 120 to restore the state in which the primary menu is displayed on the first path 121. In this case, the selection for a specific menu and the execution of the operation matched to the selected menu are not performed. Such a process can be seen from FIGS. 8A to 8D. Details of the process can be inferred from FIGS. 5 and 7A to 7E. Thus, detailed explanation thereof will be omitted.

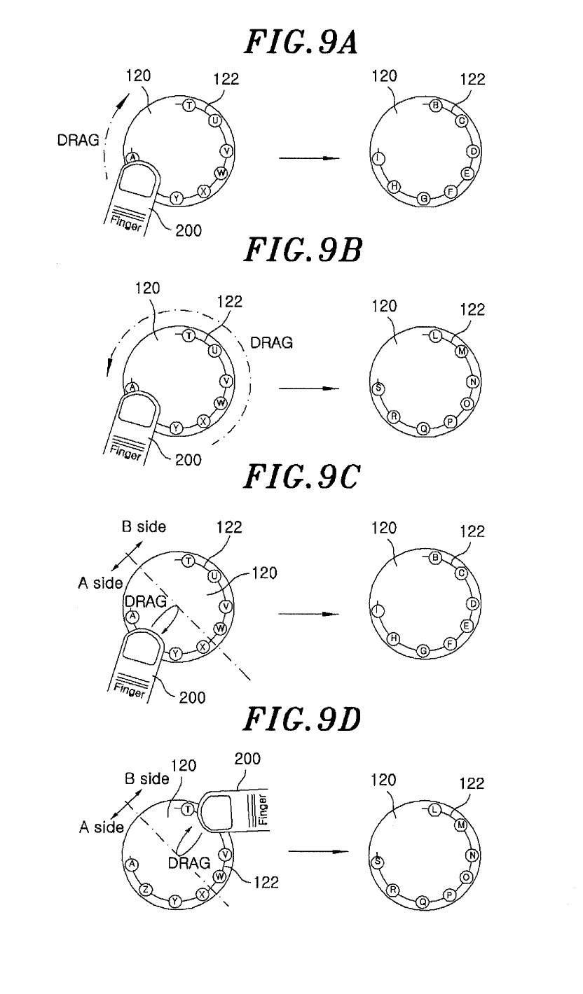

FIGS. 9A to 9D are diagrams showing a process of changing the display state of a menu by a drag operation in the electronic device having a multi-stage menu selection function according to one embodiment of the present disclosure. Matters not mentioned in the description of FIGS. 9A to 9D below can be inferred and understood with reference to the description of FIGS. 7A to 7E and 8A to 8D.

Referring to the left diagram of FIG. 9A, dragging may be started from a start position on the second path 122 of the display 120. The finger 200 may pass through one end of the second path 122 (the end at which the 1^{st} menu “A” is displayed), deviate from the second path 122, and reach the other end of the second path 122 (the end at which the 20^{th} menu “T” is displayed). Thereafter, the dragging may be completed by releasing the finger 200. When such an operation is executed, the kinds of the menus displayed on the second path 122 are changed as shown in the right diagram of FIG. 9A.

In contrast, as shown in FIG. 9B, the dragging may be performed in the opposite direction. Specifically, as shown in the left diagram of FIG. 9B, dragging may be performed along the second path 122 of the display 120 in the direction indicated by the arrow. The finger 200 may pass through the end of the second path 122 at which the 20^{th} menu “T” is displayed, deviate from the second path 122, and reach the end of the second path 122 at which the 1^{st} menu “A” is displayed. Thereafter, the dragging may be completed by releasing the finger 200. Then, the kinds of the menus displayed on the second path 122 may be changed as shown in the right diagram of FIG. 9B.

In the case of FIG. 9B, the dragging direction is opposite to that of FIG. 9A. Thus, the kinds of the menus newly displayed on the second path 122 are different from those of FIG. 9A. For example, in FIG. 9A, the dragging may be performed so that the finger 200 deviates from the second path 122 at the position where the 1^{st} menu “A” is displayed. Thus, eight menus including the 1^{st} menu “A” and the subsequent menus, namely the 2^{nd} menu “B” to the 9^{th} menu “I”, may be displayed on the second path 122. In FIG. 9B, the dragging may be performed so that the finger 200 deviates from the second path 122 at the position where the 20^{th} menu “T” is displayed. Thus, eight menus including the 20^{th} menu “T” and the preceding menus, namely the 12^{th} menu “L” to the 19^{th} menu “S”, are displayed on the second path 122.

In the case explained above, the newly displayed menus may be the menus matched to a non-display region adjacent to the non-display region to which the originally displayed menus are matched. As a matter of course, this is nothing more than one example. The number of menus displayed at once on the second path 122 and the kinds of menus newly displayed on the second path 122 by the dragging may be differently set.

On the other hand, the operation for switching the kind of the menus displayed on the second path 122 is not necessarily limited to the operation illustrated in FIGS. 9A and 9B. For example, referring to FIGS. 9C and 9D, the same effect as in FIGS. 9A and 9B may be achieved by a drag operation of merely starting from an arbitrary position on the second path 122, passing through a position deviated from the second path 122 and then returning to a position on the second path 122 (which may be the same as or different from the start position). Specifically, as shown in FIGS. 9C and 9D, the second path 122 may be divided in half. The area on the display 120 to which one half belongs may be defined as an “A side.” The area on the display 120 to which the other half belongs, namely the area other than the A side may be defined as a “B side.” In this case, the same operation as in the example of FIG. 9A may be executed by a drag performed on the side A as shown in FIG. 9C. The same operation as in the example of FIG. 9B may be executed by a drag performed on the side B as shown in FIG. 9D.

According to the embodiment shown in FIGS. 9A to 9D, even when the user accidentally touches unintended non-display region, the kinds of the menus displayed on the second path 122 may be changed by a drag operation continuously performed with the already-performed touch without having to make another touch again. Thus, it is possible to more conveniently input characters through a touch in the electronic device 100.

The combinations of respective sequences of a flow diagram attached herein may be carried out by computer program instructions. Thus, a non-transitory computer-readable recording medium can store a program causing a computer to perform the respective steps of a multi-stage menu selection method of the present disclosure. Since the computer program instructions may be loaded in processors of a general purpose computer, a special purpose computer, or other programmable data processing apparatus, the instructions, carried out by the processor of the computer or other programmable data processing apparatus, create means for performing functions described in the respective sequences of the sequence diagram. Since the computer program instructions, in order to implement functions in specific manner, may be stored in a memory useable or readable by a computer or a computer aiming for other programmable data processing apparatus, the instruction stored in the memory useable or readable by a computer may produce manufacturing items including an instruction means for performing functions described in the respective sequences of the sequence diagram. Since the computer program instructions may be loaded in a computer or other programmable data processing apparatus, instructions, a series of sequences of which is executed in a computer or other programmable data processing apparatus to create processes executed by a computer to operate a computer or other programmable data processing apparatus, may provide operations for executing functions described in the respective sequences of the flow diagram.

Moreover, the respective sequences may indicate some of modules, segments, or codes including at least one executable instruction for executing a specific logical function(s). In some alternative embodiments, it is noted that the functions described in the sequences may run out of order. For example, two consecutive sequences may be substantially executed simultaneously or often in reverse order according to corresponding functions.

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention. Therefore, the exemplary embodiments disclosed herein are not used to limit the technical idea of the present invention, but to explain the present invention, and the scope of the technical idea of the present invention is not limited to these embodiments. Therefore, the scope of protection of the present invention should be construed as defined in the following claims and changes, modifications and equivalents that fall within the technical idea of the present invention are intended to be embraced by the scope of the claims of the present invention.

What is claimed is:

1. An electronic device having a multi-stage menu selection function for selecting one of n menus where n is a natural number of 2 or more, and including a display, an input unit and a control unit,
wherein when m is a natural number of 1 or more and less than n, a first path and a second path are defined on the display, m first display regions are defined on the first path, regions existing on the first path and not belonging to the first display regions are defined as non-display regions, and each of the non-display regions exists between two adjacent first display regions;
the control unit is configured to control the display so that m primary menus among the n menus are respectively displayed on the m first display regions and so that when an input for selecting one of the non-display regions is detected by the input unit after the primary menus are displayed, each of one or more menus matched to the selected non-display region among the n menus is displayed on one of a plurality of second display regions defined on the second path.

2. The device of claim 1, wherein the control unit is configured, when the input unit detects an input for selecting one of the n menus displayed on the first display regions or the second display regions, to perform an operation matched to the selected menu.

3. The device of claim 1, wherein when the input unit detects an input for selecting one of the primary menus displayed on the first display regions, the control unit controls the display so that each of menus matched to one of the non-display regions adjacent to the selected primary menu is displayed on one of the second display regions, and
wherein when the input unit detects an input for selecting one of the menus displayed on the second display regions, the control unit performs an operation matched to the selected menu.

4. The device of claim 1, wherein the display is a touch screen type display, the input unit is configured to detect a touch to a position on the display, and the control unit is configured to, when a touch to a specific position on the display is detected, presume that an input for selecting the specific position is detected.

5. The device of claim 1, wherein the first display regions are arranged on the first path at regular intervals and the second display regions are arranged on the second path at regular intervals.

6. The device of claim 1, wherein the primary menus are defined based on an input received by the input unit from a user of the electronic device or a selection frequency of the user for the n menus.

7. The device of claim 4, wherein the n menus have a predetermined order of from 1 to n.

8. The device of claim 7, wherein each of the first path and the second path is defined in the form of a loop formed along a peripheral edge portion of the display.

9. The device of claim 7, wherein the primary menus are selected from the n menus at a regular interval in the predetermined order.

10. The device of claim 8, wherein the input unit includes a touch detection unit which surrounds the peripheral edge portion of the display and is configured to detect a touch, and
wherein the control unit is configured to, when the touch detection unit detects a touch to a specific position thereon, presume that an input for selecting a region including a point at which the first path intersects a straight line starting from a point on the display corresponding to a center of the first path and passing through the specific position is detected.

11. The device of claim 7, wherein the control unit is configured to control the display so that the primary menus are arranged in the predetermined order along the first path when the primary menus are displayed,
wherein menus matched to any one region among the non-display regions include, when it is assumed that two menus respectively displayed on two first display regions adjacent to the one region are p^{th} and q^{th} menus among the n menus and that q is larger than p, the menus between the p^{th} menu and the q^{th} menu inclusive, and
wherein the control unit is configured to, when an input for selecting the one region is detected by the input unit, control the display so that the menus matched to the selected one region are arranged in the predetermined order along the second path when the menus matched to the selected one region are displayed.

12. The device of claim 1, wherein the display is a touch screen type display,
wherein the input unit is configured to detect a drag with respect to the display, and
wherein the control unit is configured to, when a predetermined drag is detected by the input unit in a state in which the one or more menus matched to the selected non-display region are displayed, control the display so that each of one or more menus matched to one of the non-display regions adjacent to the selected non-display region is displayed on one of the second display regions.

13. The device of claim 4, wherein the control unit is configured to, when a drag which is performed continuously with a touch for selecting the one of the non-display regions and is terminated on a menu displayed on the second path is detected by the input unit, presume that the menu on which the drag is terminated is selected.

14. A multi-stage menu selection method for selecting one of n menus where n is a natural number of 2 or more, in an electronic device including a display, the method comprising:
a first step of, when m is a natural number of 1 or more and less than n, respectively displaying m primary menus among the n menus on m first display regions on a first path defined on the display;
a second step of, when regions existing on the first path and not belonging to the first display regions are defined as non-display regions each of which exists between two adjacent first display regions, detecting an input for selecting one of the non-display regions; and
a third step of, displaying each of one or more menus matched to the selected non-display region among the n menus on one of a plurality of second display regions defined on a second path on the display.

15. The method of claim 14, further comprising a step of, when an input for selecting one of the n menus displayed on the first display regions or the second display regions is detected, causing the electronic device to perform an operation matched to the selected menu.

16. The method of claim 14, wherein the second step includes, when an input for selecting one of the primary menus displayed on the first display regions is detected, displaying each of menus matched to one of the non-display regions adjacent to the selected primary menu on one of the second display regions, and
wherein the third step includes, when an input for selecting one of the menus displayed on the second display regions, causing the electronic device to perform an operation matched to the selected menu.

17. The method of claim 14, wherein the display is a touch screen type display and, when a touch to a specific position on the display is detected, it is presumed that an input for selecting the specific position is detected.

18. The method of claim 14, wherein the first display regions are arranged on the first path at regular intervals and the second display regions are arranged on the second path at regular intervals.

19. The method of claim 14, wherein the primary menus are defined based on an input from a user of the electronic device or a selection frequency of the user for the n menus.

20. The method of claim 17, wherein the n menus have a predetermined order of from 1 to n.

21. The method of claim 20, wherein each of the first path and the second path is defined in the form of a loop formed along a peripheral edge portion of the display.

22. The method of claim 20, wherein the primary menus are selected from the n menus at a regular interval in the predetermined order.

23. The method of claim 21, wherein the electronic device further includes a touch detection unit which surrounds the peripheral edge portion of the display and is configured to detect a touch, and
wherein, when the touch detection unit detects a touch to a specific position thereon, it is presumed that an input for selecting a region including a point at which the first path intersects a straight line starting from a point on the display corresponding to a center of the first path and passing through the specific position is detected.

24. The method of claim 20, wherein the first step includes arranging the primary menus in the predetermined order along the first path when the primary menus are displayed,
wherein menus matched to any one region among the non-display regions include, when it is assumed that two menus respectively displayed on two first display regions adjacent to the one region are p^{th} and q^{th} menus among the n menus and that q is larger than p, the menus between the p^{th} menu and the q^{th} menu inclusive, and
wherein the third step includes, when an input for selecting the one region is detected, arranging the menus matched to the selected one region in the predetermined order along the second path when the menus matched to the selected one region are displayed.

25. The method of claim 14, wherein the display is a touch screen type display, the method further comprising a step of, when a predetermined drag is detected in a state in which the one or more menus matched to the selected non-display region are displayed, displaying each of the one or more menus matched to one of the non-display regions adjacent to the selected non-display region on one of the second display regions.

26. The method of claim 17, wherein the third step includes a step of, when a drag which is performed continuously with a touch for selecting the one of the non-display regions and is terminated on a menu displayed on the second path is detected, presuming that the menu on which the drag is terminated is selected.

27. A non-transitory computer-readable recording medium storing a program causing a computer to perform the respective steps of the method of claim 14.
